(19) United States
(12) Patent Application Publication
(10) Pub. No.: US 2004/0037295 A1
(43) Pub. Date: Feb. 26, 2004

(54) Creating virtual local area network (VLAN)

(76) Inventors: Hiroki Tanaka, Abiko-shi (JP); Takeshi Koide, Tokyo (JP)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/400,935

(22) Filed: Mar. 28, 2003

(30) Foreign Application Priority Data
Mar. 28, 2002 (JP) 2002-090877

(51) Int. Cl. H04L 12/28

(52) U.S. Cl. 370/395.53; 370/395.2

(57) ABSTRACT

A method to selectively connect a plurality of network devices together using a graphical user interface (GUI) and a display, and an apparatus to perform such a method includes: displaying an object indicative of a first network device and an object indicative of a second network device on the display; and logically connecting the first network device to the second network device in response to the object indicative of the first network device and the object indicative of the second network device being selected using the GUI.

### BACKGROUND OF THE INVENTION

1. Field of the Invention

The present invention is related to a computer network. More specifically, the present invention is related to creating a virtual local area network (VLAN) using a graphical user interface (GUI) and a display to set structural devices.

2. Description of the Related Art

The duty ratio of traffic on a network caused by a broadcast is increased when there is an increase in a scale of a LAN (Local Area Network), resulting in an increased communication load over the entire LAN. One effective way to reduce this duty ratio is to subdivide the LAN into a plurality of broadcast domains by employing a router. Another known technique for subdividing a LAN using a high-speed/low-cost switch rather than a router entails the use of VLANs.

A VLAN includes a plurality of LANs and a VLAN switch network to connect the respective LANs. The respective LANs are connected via switches to the VLAN switch network.

In a VLAN having a first LAN connected to a second LAN via a switch network, data is transmitted from a terminal of the first LAN to a terminal of the second LAN according to the following steps:

(1) The terminal of the first LAN sends a frame to a switch that is connected to a VLAN switch network located outside the first LAN. A header having destination information is added to data in the frame to be sent.

(2) The switch that has received the frame adds a tag containing a VLAN ID indicative of the second LAN and corresponding to a destination of this frame, and then sends the resultant frame to a switch that is employed in the VLAN switch network and is connected to the second LAN of the destination.

(3) The switch containing the VLAN ID indicative of the second LAN indicated in the tag is connected to the second LAN corresponding to the destination. This switch accepts the frame having the tag, removes the tag therefrom, and then sends the resultant frame to a destination terminal of the second LAN.

On the other hand, a plurality of LANs can be configured via switches into a single VLAN by executing a method called: “VLAN Trunking.”

As shown in FIG. 1, for example, when such a VLAN is created, a LAN is connected to a switch, and a command group 100 is transmitted from a terminal connected to the LAN to a port of the LAN and the switch, and creates respective configurations of this port and this switch so as to establish a correlative relationship between the switch and a VLAN ID. In order to produce a command for creating the configurations, a configuration of the VLAN and information regarding the device connected to this VLAN must be acquired.

However, when a VLAN is created by partially employing a communication line such as a virtual private network (VPN), and/or by partially using a public network such as the Internet, there is a possibility that traffic caused by other VPNs is physically jammed in the communication line portion of the VPN and/or the public network portion. In such a case, one private network can be logically discriminated from other private networks only by configurations that have been set in a switch and a port.

As a consequence, when an erroneous configuration is inadvertently created, there is a risk of information of one private network being erroneously transferred to another private network.

In order to avoid such errors, those creating a VLAN must have a great deal of expertise, and also, lengthy expensive confirmation procedures must be repeatedly carried out.

### SUMMARY OF THE INVENTION

An object of the present invention is to provide a new and improved method and apparatus to minimize errors that occur when a network device configuration is created.

Another object of the present invention is to provide a new and improved method and apparatus to easily create network device configurations.

A further object of the present invention is to provide a system that can be correctly and readily created by those who do not have a great deal of expertise with regard to creating network device configurations.

A further object of the present invention is to provide a new and improved method and apparatus to easily check that a VLAN has been correctly created.

A further object of the present invention is to provide a new and improved method and apparatus to previously acquire network device information so as to easily create a VLAN.

A further object of the present invention is to provide a new and improved method and apparatus to reduce the required number of confirmation procedures needed when a VLAN is created.

A further object of the present invention is to provide a new and improved method and apparatus to reduce the required number of input operations effected by manipulating a keyboard and to decrease erroneous input operations, such as typing errors, when creating a VLAN.

A further object of the present invention is to provide a new and improved method and apparatus to monitor network devices.

In accordance with the present invention, a VLAN creating method and apparatus is provided. That is, for example, a method of creating a VLAN having a network, a first LAN, and a second LAN, using a GUI and a display, comprises: displaying an object indicative of a first network device in the network and an object indicative of a second network device in the network on the display; displaying an object indicative of a network device in the first LAN and an object indicative of a network device in the second LAN on the display; logically connecting a first connection device in the network to a connection device in the first LAN in response to an object indicative of the first connection device in the network and an object indicative of the connection device in the first LAN being selected using the GUI; and logically connecting a second connection device in the network to a connection device in the second LAN in response to an object indicative of the second connection device in the network and an object indicative of the connection device in the second LAN being selected using the GUI.

In such a VLAN creating method, logically connecting the first connection device in the network to the connection device in the first LAN can include sending connection information to the first connection device in the network and the connection device in the first LAN; and logically connecting the second connection device in the network to the connection device in the second LAN can include sending connection information to the second connection device in the network and the connection device in the second LAN.

In accordance with another aspect of the present invention, a method and apparatus to selectively connect a plurality of network devices together is provided. That is, for example, a method of selectively connecting a plurality of network devices together using a GUI and a display comprises: displaying an object indicative of a first network device and an object indicative of a second network device on the display; and logically connecting the first network device to the second network device in response to the object indicative of the first network device and the object indicative of the second network device being selected using the GUI.

In such a plural network devices connecting method, logically connecting the first network device to the second network device can include sending connection information to the first network device and the second network device.

In such a plural network devices connecting method, displaying the object indicative of the first network device and the object indicative of the second network device on the display can include acquiring configuration information of the first network device and configuration information of the second network device.

In such a plural network devices connecting method, logically connecting the first network device to the second network device in response to the object indicative of the first network device and the object indicative of the second network device being selected, can include logically connecting the first network device to the second network device in response to an input signal of an input device of the GUI, such as a mouse.

In such a plural network devices connecting method, logically connecting the first network device to the second network device in response to the object indicative of the first network device and the object indicative of the second network device being selected, can include displaying on the display, an object to connect the object indicative of the first network device to the object indicative of the second network device.

In accordance with a further aspect of the present invention, a method and apparatus to selectively connect a plurality of network devices together is provided. That is, for example, a method of selectively connecting a plurality of network devices together using a GUI and a display comprises: detecting that information of a first network device has been acquired; and logically connecting the first network device to a second network device in response to detecting that information of the first network device has been acquired.

In accordance with a further aspect of the present invention, a method and apparatus to selectively logically connect a plurality of objects together is provided. That is, for example, a method of selectively logically connecting a plurality of objects together using a GUI and a display comprises: detecting that information of a first object has been acquired; and logically connecting the first object to a second object in response to detecting that information of a first object has been acquired.

In accordance with a further aspect of the present invention, a method and apparatus to selectively logically connect a plurality of objects together is provided. That is, for example, a method of selectively logically connecting a plurality of objects together using a GUI and a display comprises: detecting that information of a first object has been selected using the GUI; and logically connecting the first object to a second object in response to detecting that information of the first object has been selected.

In accordance with a further aspect of the present invention, a method and apparatus to selectively disconnect a plurality of connected network devices is provided. That is, for example, a method of selectively disconnecting a plurality of connected network devices using a GUI and a display comprises: displaying an object indicative of a first network device and an object indicative of a second network device on the display; and logically disconnecting a connection of the first network device and the second network device in response to the object indicative of the first network device and the object indicative of the second network device being selected using the GUI.

In accordance with a further aspect of the present invention, a method and apparatus to selectively disconnect a plurality of connected network devices is provided. That is, for example, a method of selectively disconnecting a plurality of connected network devices using a GUI and a display comprises: displaying an object indicative of a first network device, an object indicative of a second network device, and a connection line indicative of the first network device being logically connected to the second network device on the display; and logically disconnecting the connection of the first network device to the second network device in response to the connection line being selected using the GUI.

In accordance with a further aspect of the present invention, a method and apparatus to change connections among a plurality of network devices is provided. That is, for example, a method of changing connections among a plurality of network devices using a GUI and a display comprises: displaying an object indicative of a first network device, an object indicative of a second network device, and an object indicative of a third network device on the display; and logically disconnecting a connection of the first network device and the second network device, and logically connecting the first network device to the third network device in response to one end of an object of the first network device that has been connected to the second network device being selected and moved using the GUI to the object indicative of the third network device, the one end being located closest to the object indicative of the second network device.

In accordance with a further aspect of the present invention, a device to selectively connect a plurality of network devices together is provided. That is, for example, a device to selectively connect a plurality of network devices together using a GUI and a display comprises: a display driver to display an object indicative of a first network device and an object indicative of a second network device on the display; and a device to logically connect the first network device to the second network device in response to selecting the object indicative of the first network device and the object indicative of the second network device using the GUI.

In accordance with a further aspect of the present invention, a computer program product to selectively connect a plurality of network devices together is provided. That is, for example, a computer program product to selectively connect a plurality of network devices together using a GUI and a display comprises: a computer execution step of displaying an object indicative of a first network device and an object indicative of a second network device on the display; and a computer execution step of logically connecting the first network device to the second network device in response to the object indicative of the first network device and the object indicative of the second network device being selected using the GUI.

In accordance with a further aspect of the present invention, a method of manufacturing a VLAN is provided. That is, for example, a method of manufacturing a VLAN having a network, a first LAN, and a second LAN, using a GUI and a display comprises: displaying an object indicative of a first network device in a network and an object indicative of a second network in the network on the display; displaying an object indicative of a network device in the first LAN on the display; displaying an object indicative of a network device in the second LAN on the display; logically connecting the first connection device in the network to the connection device in the first LAN in response an object indicative of a first connection device in the network and an object indicative of a connection device in the first LAN being selected using the GUI; and logically connecting the second connection device in the network to the connection device in the second LAN in response to an object indicative of a second connection device in the network and an object indicative of a connection device in the second LAN being selected using the GUI.

In accordance with a further aspect of the present invention, a VLAN is provided. That is, for example, a VLAN having a network, a first LAN, a second LAN, a GUI, and a display, comprises: a first display driver to display an object indicative of a first network device in a network and an object indicative of a second network in the network on the display; a second display driver to display an object indicative of a network device in the first LAN on the display; a third display driver to display an object representative of a network device in the second LAN on the display; a connecting device to logically connect a first connection device in the network to a connection device in the first LAN in response to an object indicative of the first connection device in the network and an object indicative of the connection device in the first LAN being selected using the GUI; and a connecting device to logically connect a second connection device in the network to a connection device in the second LAN in response to an object indicative of the second connection device in the network and an object indicative of the connection device in the second LAN being selected using the GUI.

### BRIEF DESCRIPTION OF THE DRAWINGS

The foregoing and a better understanding of the present invention will become apparent from the following detailed description of example embodiments and the claims when read in connection with the accompanying drawings, all the forming a part of the disclosure of this invention. While the foregoing and following written and illustrated disclosure focuses on disclosing example embodiments of the present invention, it should be clearly understood that the same is by way of illustration and example only and that the present invention is not limited thereto. The spirit and scope of the present invention are limited only by the terms of the appended claims.

The following represents brief descriptions of the drawings, wherein:

FIG. 1 is a diagram of an example of a command that is sent from a terminal connected to a LAN to a port and a switch of the LAN when the LAN is connected to the switch;

FIG. 2 is a diagram of a configuration of a VLAN to which an illustrative embodiment of the present invention is applied;

FIG. 3 is a diagram of network topology displayed on a display screen of a server, according to an illustrative embodiment of the present invention;

FIG. 4 is a diagram of network topology indicated on the display screen of the server after a switch is logically connected to a core network, according to an illustrative embodiment of the present invention;

FIG. 5 is a flowchart of a method of logically connecting a switch to a core network, according to an illustrative embodiment of the present invention;

FIG. 6 is a diagram of network topology displayed on the display screen of the server, according to another illustrative embodiment of the present invention;

FIG. 7 is a diagram of network topology displayed on the display screen of the server, according to another illustrative embodiment of the present invention;

FIG. 8 is a diagram of network topology displayed on the display screen of the server, according to still another illustrative embodiment of the present invention;

FIG. 9 is a diagram of network topology displayed on the display screen of the server after a switch is logically disconnected from a core network, according to an illustrative embodiment of the present invention;

FIG. 10 is a flowchart of a method of logically disconnecting a switch from a core network, according to an illustrative embodiment of the present invention;

FIG. 11 is a diagram of network topology displayed on the display screen of the server, according to another illustrative embodiment of the present invention;

FIG. 12 is a diagram of network topology displayed on the display screen of the server after a connection of a switch to a core network is logically changed, according to an illustrative embodiment of the present invention; and

FIG. 13 is a flowchart of a program stored on a computer, the program causing the computer to perform a method of logically changing a connection of a switch to a core network, according to an illustrative embodiment of the present invention.

### DETAILED DESCRIPTION

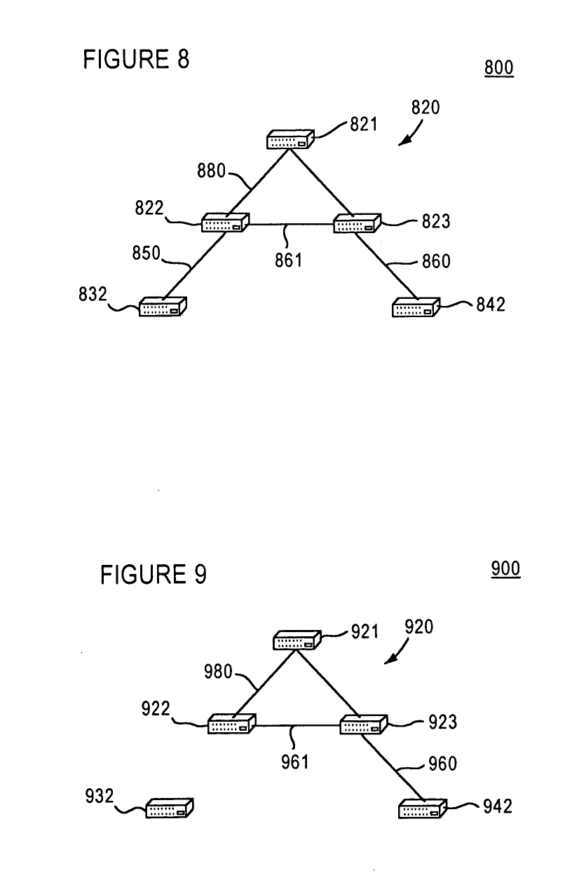

Before beginning a detailed description of the subject invention, mention of the following is in order. When appropriate, like reference numerals and characters are used to designate identical, corresponding, or similar components in differing drawing figures. In addition, reference numerals have been designated such that element 861 of FIG. 8 corresponds to element 961 of FIG. 9, for example. Furthermore, in the detailed description to follow, example sizes/models/values/ranges may be given, although the present invention is not limited thereto. Still furthermore, arrangements may be shown in block diagram form in order to avoid obscuring the present invention, and in view of the fact that specifics of implementation of such block diagram arrangements are highly dependent upon the platform within which the present invention is to be implemented, that is, such specifics should be well within the purview of one skilled in the art. Where specific details have been set forth in order to describe example embodiments of the present invention, it should be apparent to one skilled in the art that the present invention can be practiced without, or with variations of, these specific details. Finally, it should be apparent that differing combinations of hard-wired circuitry and software instructions can be used to implement embodiments of the present invention, that is, the present invention is not limited to any specific combination of hardware and software.

FIG. 2 is a diagram of the construction of a VLAN 200 including a core network 200 that is connected via a broadband network line within a VLAN switch/network. The network also includes: a LAN #A 230, another LAN #B 240, a server 250, and a database 260. The LAN #A 230 is connected via a switch 232 to a switch 222 employed in the core network 220, and the LAN #B 240 is connected via a switch 242 to a switch 223 employed in the core network 220. Also, the server 250 is connected to a switch 221 employed in the core network 220. The database 260 is connected to the server 250.

The core network 220 includes the switches 221, 222, and 223 that are directly, or indirectly connected to each other via a broadband network line. The core network 220 can be constituted by way of the Internet, or can be preferably constituted by employing a leased communication line (dedicated communication line) owned by a communications carrier. Alternatively, a network device, such as a router, and a hub can replace the switches 221, 222, and 223.

The LAN #A 230 and the LAN #B 240 correspond to LANs which are independently constructed. The LAN #A 230 and the LAN #B 240 can be physically located apart from each other, or can be physically located close to us each other.

The server 250 is connected to the switch 221 provided in the core network 220. also, the server 250 contains a keyboard 251 and an input device, such as a mouse 252.

The following is a description of a method of logically connecting the LAN #A 230 and the LAN #B 240 to the core network 220 so as to create a VLAN. The logical connection from the LANs #A/#B 230/240 to the core network 220 is created by sending connection information from the server 250 to the switches 222, 223, 232, and 242.

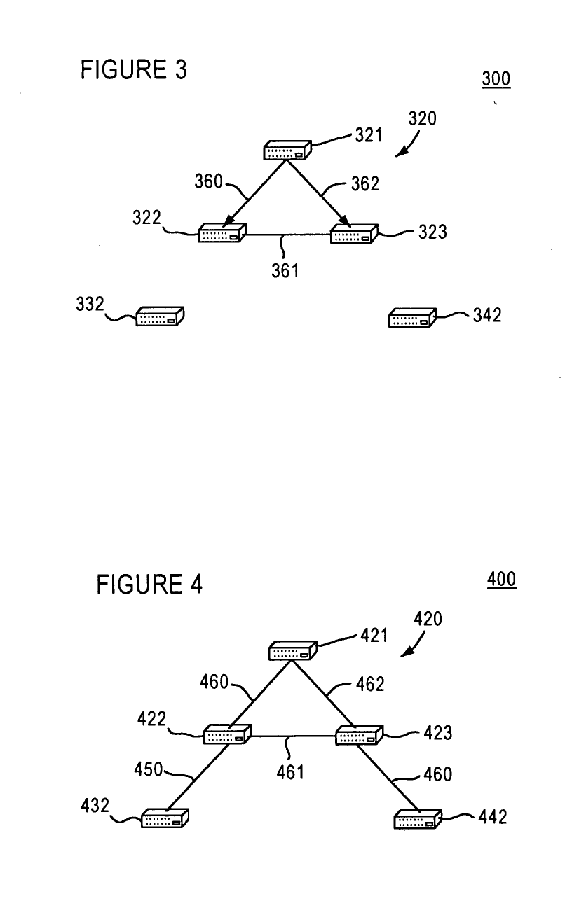

FIG. 3 is a diagram of network topology that is displayed on a display screen 300 of the server 250 (FIG. 2). The network topology includes switch objects 321, 322, 323, 332, 342, and a core network object 320. The switch objects 321, 322, 323, 332, and 342 are image objects corresponding to the switches 221, 222, 223, 232, and 242, and the core network object 320 is an image object corresponding to the core network 220 of FIG. 2. Also, the switches that have already and logically been connected to each other are shown on the display 300 as being connected to each other by solid lines 360, 361, and 362. Under initial conditions, although the switches 232 and 242 have been physically connected to the core network 220, these switches 232 and 242 are not logically connected to this core network 220. As a consequence, none of the switch objects 332 and 342 are connected to the core network object 320 by a solid line.

Configuration information, such as a property and performance of each of these switches, has previously been stored in the database 260 (FIG. 2), or can be acquired by sending a predetermined command to the relevant switch from the server 250 in response to a requirement. The configuration information of the switch that has been stored or acquired is displayed on the display screen in such a manner that the relevant switch is selected on this display screen using the keyboard 251 or clicking the right button of the mouse 252, for example.

FIG. 4 is an illustration of network topology displayed on a display screen 400 of the server 250 (FIG. 2) after the switches 232 and 242 have been logically connected to the core network 220. The network topology includes switch object images 421, 422, 423, 432, 442, and a core network object image 420. The switch object images 421, 422, 423, 432, and 442 are image objects corresponding to the switches 221, 222, 223, 232, and 242, and the core network object image 420 is an image object corresponding to the core network 220 shown in FIG. 2. The switches 232 and 242 are logically connected to the switches 222 and 223 employed in the core network 220. As a consequence, the switch object images 432 and 442 are connected to the switch object images 422 and 423 employed in the core network object 420 by a solid line 450 and another solid line 460.

The switches 232 and 242 have been registered in the database 260 as the network devices that constitute the VLAN. The connection information that constitutes the VLAN has also been sent to the switches 232 and 242 themselves.

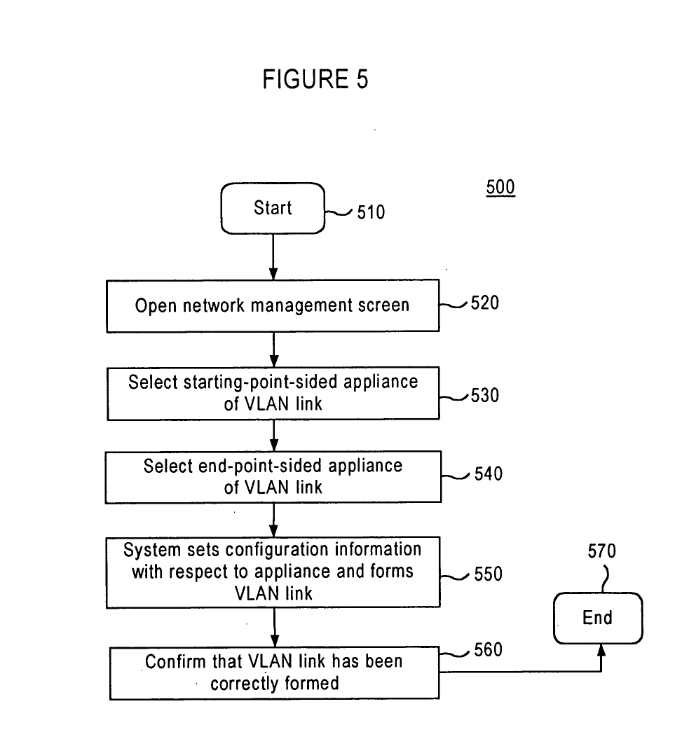

FIG. 5 is a flowchart of a program stored in a program storage device readable by a computer, tangibly embodying a program of instructions executable by the computer to perform a method of logically connecting the switches 232 and 242 to the core network 220, according to an example embodiment of the present invention. The method of logically connecting the switches 232 and 242 to the core network 220 will now be explained with reference to FIG. 3 to FIG. 5.

The connecting method begins in step 510 of FIG. 5. The server 250 opens a network management screen in step 520. As shown in FIG. 3, switches on the network and the network are displayed this network management screen. As shown in FIG. 3, the switches 232 and 242 are initially not logically connected to core network 220. As a consequence, the switch objects 332 and 342 are not connected to the core network object 320 by a solid line. However, configuration information, such as the properties and the performance as to the switches 232 and 242, has previously been stored in the database 260, or has previously been acquired in response to a command. Either the switch object image 332 or the switch object image 342 is selected using a mouse 252 or keyboard 251, for example, by performing a predetermined operation (for example, by clicking the right hand button of the mouse 252), to display the configuration information of the switches 232 and 242 on the network management screen.

A device provided on the starting point side of a VLAN Link is selected in step 530. That is, as shown in FIG. 3, the switch object image 322 is selected as the starting-point-sided device of the connection by operating an input device, such as the mouse 252 or keyboard 251.

An end-point-sided device of the VLAN Link is selected in step 540. That is, as shown in FIG. 3, the switch object 332 is selected as the end-point-sided device of the connection by operating an input device, such as the mouse 252 or keyboard 251. When a starting-point-sided device and an end-point-sided device have been selected, the mouse 252 pointer is then put on the starting-point-sided device and a right button of this mouse 252 pointer is clicked; the mouse 252 pointer is then dragged onto the end-point-sided device, and when the mouse 252 pointer has been moved on to the end-point-sided device, the mouse 252 pointer is dropped.

The order of selecting the starting-point-sided device of step 530 and the endpoint-sided device of step 540 can be opposite to that described above.

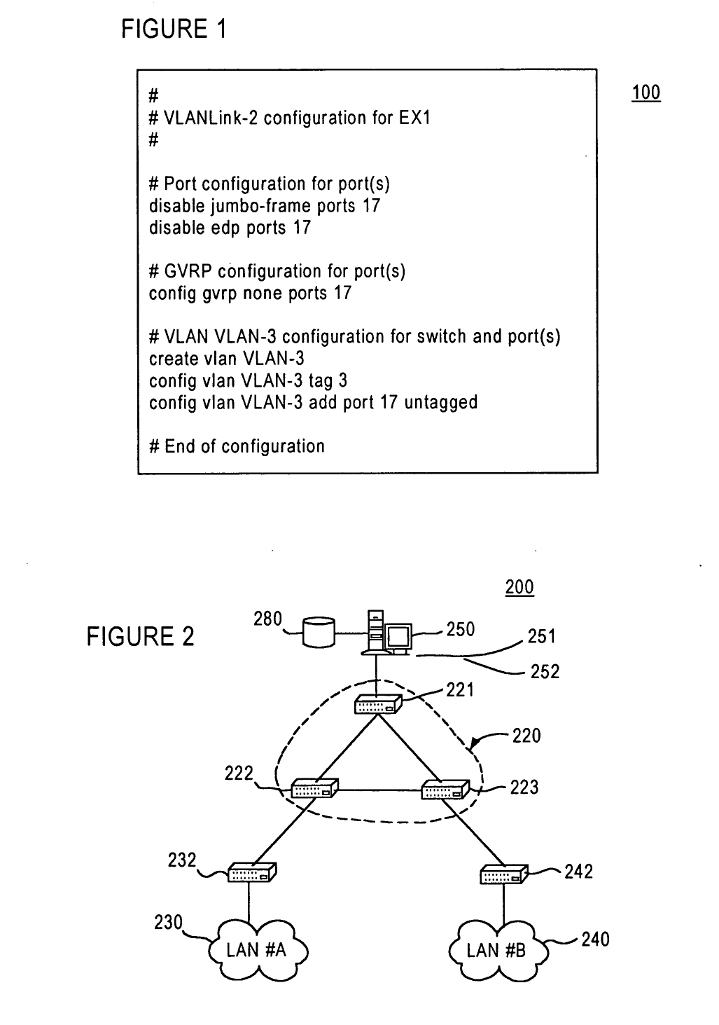

The system automatically creates the configuration information of the devices so as to form a VLAN (Virtual Local Area Network) Link in step 550. That is, the server 250 automatically issues commands (that is, instructions) having a format, as shown in FIG. 1, based upon the configuration information of the switches 222 and 232, and the information specifying the starting-point-sided device and the end-point-sided device entered in steps 530 and 540. The switch 222 command contains a message to connect the switch 222 to the switch 232 and an ID thereof, and the switch 232 command contains a message to connect the switch 232 to the switch 222 and an ID thereof. As a result, the connection information of the switches 222 and 232 is created.

A confirmation procedure determines if the VLAN Link has been correctly formed in step 560. If the VLAN Link has been correctly formed, the server 250 connects the switch object image 432 to the core network object image 420 by a solid line 450 based upon the created connection information, and then displays the connected object images 432/420. The process is effected, in step 570, when the VLAN Link has been correctly created.

A predetermined command is sent from the server 250 to a switch so as to acquire connection information of the relevant switch in the confirmation step 560. It is also possible to determine whether or not a link of a logic network has been correctly operated by continuously or periodically acquiring connection information. The server 250 can notify an operator of this abnormal state (that is, a fault management function) when an abnormal condition has been sensed.

Process operations defined in steps 530 to 560 are similarly and repeatedly carried out when the switch 223 and the switch 242 are connected to the network 220. It should also be understood that the starting-point-sided device and the end-point-sided device are not necessarily and clearly selected. For example, since a connection point (starting-point-sided device) in an existing network has been previously determined, when a network device (end-point-sided device) is newly added, this newly-added device could be selected to form a VLAN Link. Otherwise, configuration information of this newly added device could be acquired to form the VLAN Link.

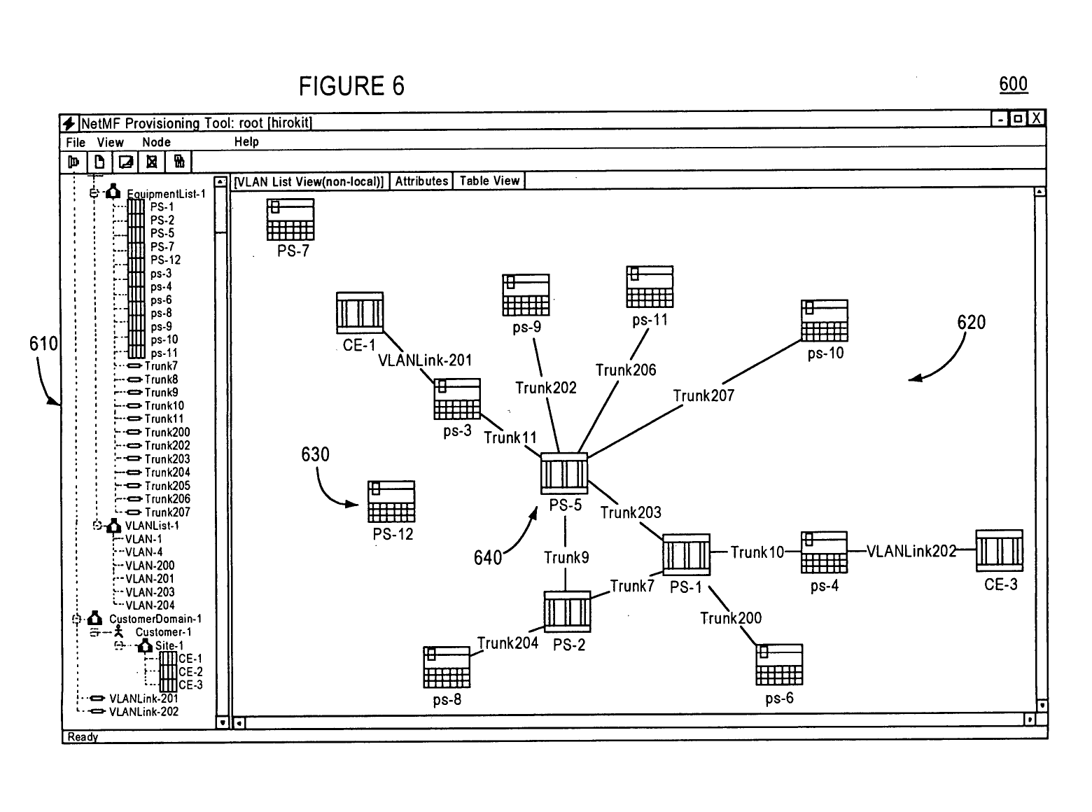

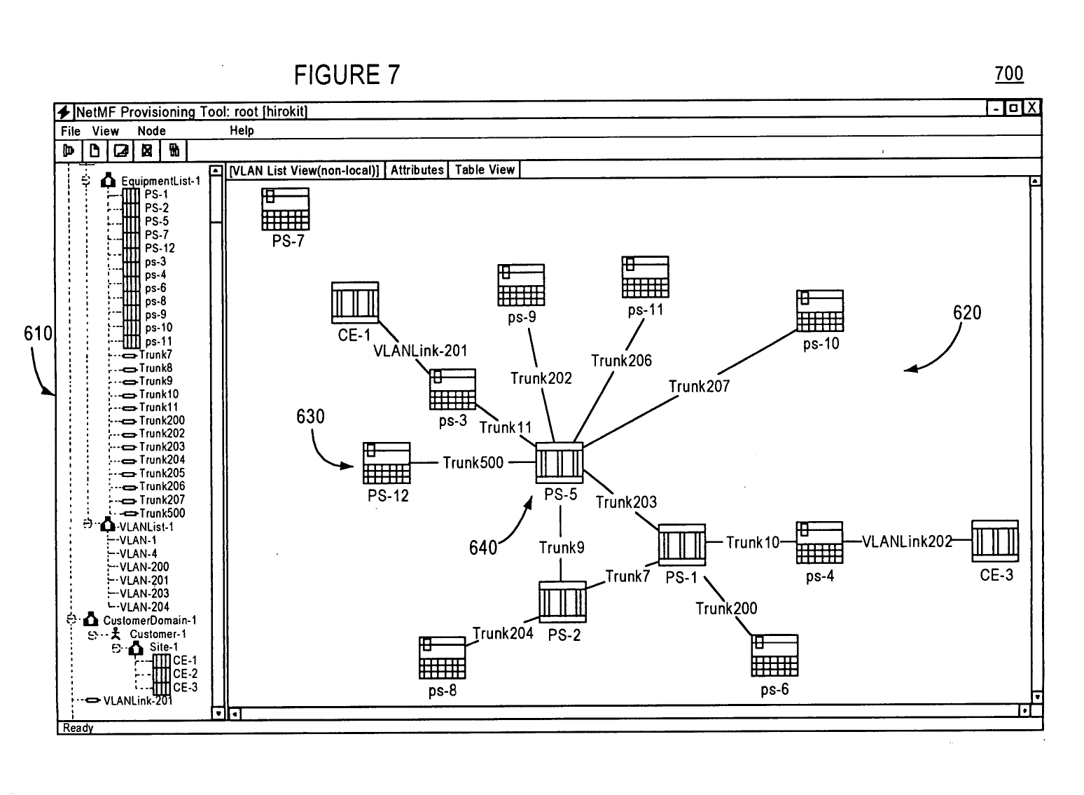

FIGS. 6 and 7 are diagrams of network topology displayed on the display screen of the server 250, according to another embodiment in accordance with the present invention. In FIG. 6, a network management screen 600 displayed on the display screen contains a VLAN list view 610 and a topology view 620.

In FIG. 6, network devices for constituting the selected VLAN and connection conditions thereof are displayed on the topology view 620 when a VLAN whose topology is to be displayed is selected from a VLAN list indicated in a tree structure in the VLAN list view 610. The server 250 cannot be erroneously connected to other VLANs by executing operations on the display screen since other network devices for constituting other VLANs that have not been selected and the connection conditions thereof are not displayed on the topology view 620. As a consequence, if different VLAN names are selected, then erroneously connecting one LAN to another LAN can be eliminated.

When a LAN is additionally connected to the existing VLAN, a switch 630 corresponding to a port of the LAN to be added is connected to a switch 640 employed in the existing VLAN using the method of FIG. 5. FIG. 7 shows a network management screen 700 after the connection.

Similarly, a LAN can be removed from an existing VLAN, and a switch connected to a LAN can be changed.

FIG. 8 shows network topology displayed on the display screen 300 of the server 250 (FIG. 2) according to another embodiment in accordance with the present invention. Switch object images 821, 822, 823, 832,and 842, and a core network object image 820 are shown in FIG. 8. The switch images 821, 822, 823, 832, and 842 are image objects corresponding to the switches 221, 222, 223, 232, and 242, and the core network object image 820 is an image object corresponding to the core network 220 of FIG. 2. The switch object images 832 and 842 are connected to the switch object images 822 and 823 employed in the core network object 820 by a solid line 850 and another solid line 860.

FIG. 9 shows network topology displayed on a display screen 900 of the server 250 (FIG. 2) after the switch 232 has been logically disconnected from the core network 220. Switch object images 921, 922, 923, 932, and 942, and a core network object image 920 are shown in FIG. 9. The switch object images 921, 922, 923, 933, and 942 are image objects corresponding to the switches 221, 222, 223, 232, and 242, and the core network object image 920 is an image object corresponding to the core network 220 of FIG. 2. The switch 232 is logically disconnected from the switch 222 employed in the core network 220. As a result, the switch object image 932 is no longer connected to the switch object image 922 employed in the core network object image 920.

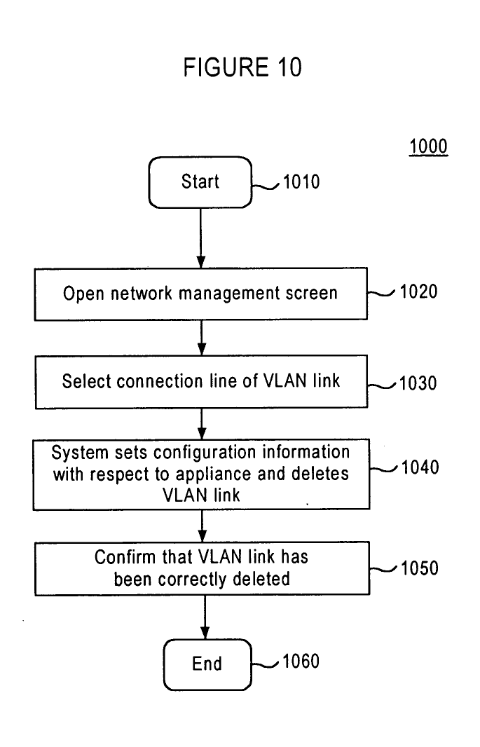

FIG. 10 is a flowchart describing a method stored in a program storage device readable by a computer, tangibly embodying a program of instructions executable by the computer to perform a method of logically disconnecting switches 232 and 242 from the core network 220 in accordance with an embodiment of the present invention. Referring to FIGS. 8 to 10, the following is a description of a method of logically disconnecting the switches 232 and 242 from the core network 220.

The computer begins the method in step 1010. A network management screen is opened in the server 250 in step 1020. Switches on the network and the network are displayed on the network management screen of FIG. 8. The switch 232 is initially logically connected to core network 220. As a consequence, the switch object image 832 is connected to the core network object image 820 by a solid line.

A connection line 850 of the VLAN Link is selected in step 1030. In other words, the connection line 850 to connect the switch object image 822 to the switch object image 832 is selected as a logic connection to be deleted by operating an input device, such as a mouse 252 or a keyboard 251.

The server 250 automatically creates configuration information of the switches 222 and 232, and deletes the VLAN link in step 1040. The server 250 automatically issues a command to delete the connection to switches 222 and 232. As a result, connection information indicating that switches 222 and 232 are connected is deleted from the connection information of switches 222 and 232.

A confirmation procedure determines if the VLAN link has been correctly deleted in step 1050. If the VLAN Link has been correctly deleted, the server 250 no longer indicates the solid line that connects the switch object 832 to the core network object 820. After the VLAN Link has been correctly deleted, the process operation is ended in step 1060.

Next, the switches 223 and 242 are disconnected, and the process operations defined in steps 1030 to 1050 are repeatedly carried out in a similar manner.

It should also be understood that a connection line is not necessarily and clearly selected. For example, since a switch object to be deleted is selected in a deletion mode, this relevant switch and all of the VLAN Links that are connected to each other can be deleted.

Alternatively, instead of the connection line being selected in step 1030, a starting-point-sided device and an end-point-sided device are selected to specify a connection to be deleted in a manner similar to the example shown in FIG. 5.

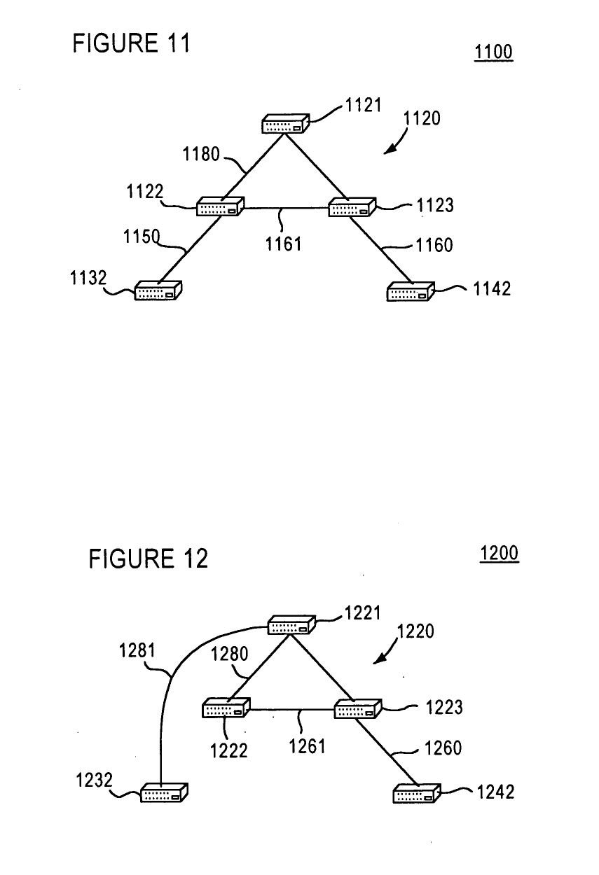

FIG. 11 shows network topology displayed on the display screen 300 of the server 250 (FIG. 2) according to another embodiment of the present invention. FIG. 11 shows switch object images 1121, 1122, 1123, 1132, and 1142, and a core network object image 1120. The switch object images 1121, 1122, 1123, 1132, and 1142 are image objects corresponding to the switches 221, 222, 223, 232, and 242, and the core network object image 1120 is an image object corresponding to the core network 220 shown in FIG. 2. The switch object images 1132 and 1142 are connected to the switch object images 1122 and 1123 employed in the core network object image 820 by solid lines 1150 and 1160.

FIG. 12 shows network topology displayed on a display screen 1200 of the server 250 (FIG. 2) after the switch 232 has logically changed a connection point of the core network 220 from the switch 222 to the switch 221, namely after the switch 232 has been disconnected from the switch 222 and then logically connected to the switch 221. FIG. 12 shows switch object images 1221, 1222, 1223, 1232, and 1242, and a core network object image 1220. The switch object images 1221, 1222, 1223, 1232, and 1242 are image objects corresponding to the switches 221, 222, 223, 232, and 242, and the core network object image 1220 is an image object corresponding to the core network 220 shown in FIG. 2. The switch 232 is logically disconnected from the switch 222 of the core network 220, and then logically connected to the switch 221. As a result, although the switch object image 1232 is not connected to the switch object image 1222 of the core network object 1220, this switch object image 1232 is connected to the switch object 1221 by a solid line 1281.

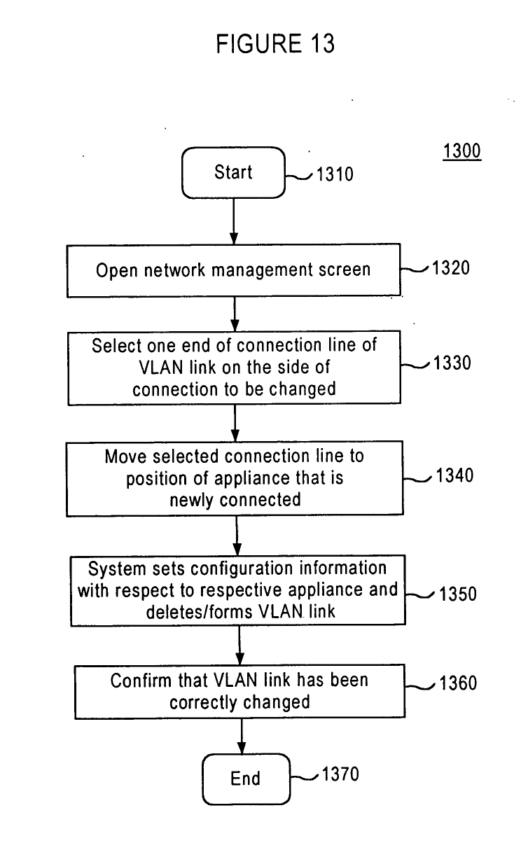

FIG. 13 shows a flowchart for explaining a method, executed by a computer according to the present invention, in which the switch 232 logically changes the connection point of the core network 220 from the switch 222 to the switch 221. With reference to FIG. 11 to FIG. 13, a description follows of a method in which the switch 232 changes the connection point of the core network 220 from the switch 222 to the switch 221.

The logical changing method is begun in step 1310. A network management screen is opened in the server 250 in step 1320. As indicated in FIG. 11, switches on the network and the network are displayed on this network management screen. Thee switch 232 is initially logically connected to the switch 222 of the core network 220. As a consequence, the switch object 1132 is connected to the switch object 1122 of the core network object 1120 by a solid line 1150.

A selection is made of one end of the connection line 1150 of the VLAN Link on the connection side to be changed in step 1330. That is, as shown in FIG. 11, the end on the side of the switch object 1122 of the connection line connecting the switch object 1122 to the switch object 1132 is selected as a logic connection to be changed by an input device, such as a mouse 252 or a keyboard 251.

In step 1340, the connection line selected in step 1330 is moved from a position of the switch object image 1122 whose connection to be disconnected to a position of the switch object image 1121 to be connected by performing a drag-and-drop operation of the mouse 252, for example.

The server 250 automatically creates configuration information of the switches 222, 232, and 221, and changes the VLAN Link in step 1350. That is, the server 250 automatically issues a command to delete the connection to switches 222 and 232. The server 250 automatically issues a command to create the connection to switches 221 and 232. As a result, connection information indicating that switch 222 is connected to switch 232 within the connection information of switches 222 and 232 is deleted, and furthermore, connection information indicating that the switch 221 is connected to the switch 232 within the connection information of switches 221 and 232 is created.

The command of the switch 232 could be realized by a command changing the connection destination from switch 222 to switch 221.

A confirmation procedure determines if the VLAN Link has been correctly changed in step 1350. If the VLAN Link has been correctly changed, the server 250 no longer displays the solid line connecting the switch object image 1232 to the switch object image 1222 of the core network object image 1220, and newly displays the solid line 1180 connecting the switch object image 1232 to the switch object image 1221 of the core network object image 1220 based upon the newly created connection information. After the VLAN Link has been correctly changed, the process operation is ended in step 1370.

A connection line is not necessarily clearly selected. Alternatively, selecting a switch object image of a changing source and a switch object image of a changed destination can change the VLAN Link.

Also, similar to the example shown in FIG. 5, a connection to be changed can be specified by selecting a device of a changing source and a device of a changed destination instead of a selection of the connection line as in step 1330.

The present invention can be realized by hardware, software, or by combinations of hardware and software. Also, the present invention can be assembled into a computer program product capable of executing these methods on a computer system.

In accordance with the present invention, network device configuration errors created by an operator can be minimized.

In accordance with the present invention, an operator can readily create network device configurations.

In accordance with the present invention, a system can be provided which can correctly and easily create network device configurations without needing a high expertise.

In accordance with the present invention, one can easily check whether a VPN has been correctly created.

In accordance with the present invention, the VPN can be readily created since network device information has been previously acquired.

In accordance with the present invention, a reduced number of confirmation procedures are performed when the VPN is created.

In accordance with the present invention, a decreased number of input operations by the keyboard are needed and erroneous input operations, such as typing errors, can be reduced.

In accordance with the present invention, the network devices can be monitored.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the spirit and scope of the foregoing disclosure, the drawings, and the appended claims without departing from the spirit of the present invention. In addition to variations and modifications in the component parts and/or arrangements, alternative uses will also be apparent to those skilled in the art.

What is claimed is:

1. A method of creating a virtual local area network (VLAN) having a network, a first local area network (LAN), and a second LAN, using a graphical user interface (GUI) and a display, comprising:
displaying an object indicative of a first network device in the network and an object indicative of a second network device in the network on the display;
displaying an object indicative of a network device in the first LAN and an object indicative of a network device in the second LAN on the display;
logically connecting a first connection device in the network to a connection device in the first LAN in response to selecting an object indicative of the first connection device in the network and an object indicative of the connection device in the first LAN using the GUI; and
logically connecting a second connection device in the network to a connection device in the second LAN in response to selecting an object indicative of the second connection device in the network and an object indicative of the connection device in the second LAN using the GUI.

2. The virtual local area network (VLAN) creating method as claimed in claim 1, wherein:
logically connecting the first connection device in the network to the connection device in the first LAN comprises sending connection information to the first connection device in the network and the connection device in the first LAN; and
logically connecting the second connection device in the network to the connection device in the second LAN comprises sending connection information to the second connection device in the network and the connection device in the second LAN.

3. A method of selectively connecting a plurality of network devices together using a graphical user interface (GUI) and a display, comprising:
displaying an object indicative of a first network device and an object indicative of a second network device on the screen of the computer; and
logically connecting the first network device to the second network device in response to selecting the object indicative of the first network device and the object indicative of the second network device using the GUI.

4. The method of selectively connecting a plurality of network devices together as claimed in claim 3, wherein:
logically connecting the first network device to the second network device comprises sending connection information to the first network device and the second network device.

5. The method of selectively connecting a plurality of network devices together as claimed in claim 3, wherein:
displaying the object indicative of the first network device and the object indicative of the second network device on the display comprises acquiring configuration information of the first network device and configuration information of the second network device.

6. The method of selectively connecting a plurality of network devices together as claimed in claim 3, wherein:
logically connecting the first network device to the second network device in response to the object indicative of the first network device and the object indicative of the second network device being selected comprises logically connecting the first network device to the second network device in response to an input signal of an input device of the GUI.

7. The method of selectively connecting a plurality of network devices together as claimed in claim 3, wherein:
logically connecting the first network device to the second network device in response to the object indicative of the first network device and the object indicative of the second network device being selected comprises displaying, on the display, an object to connect the object indicative of the first network device to the object indicative of the second network device.

8. A method of selectively connecting a plurality of network devices together using a graphical user interface (GUI) and a display, comprising:
detecting that information of a first network device has been acquired; and
logically connecting the first network device to a second network device in response to detecting that information of the first network device has been acquired.

9. A method of selectively logically connecting a plurality of objects together using a graphical user interface (GUI) and a display, comprising:
detecting that information of a first object has been acquired; and
logically connecting the first object to a second object in response to detecting that information of the first object has been acquired.

10. A method of selectively disconnecting a plurality of connected network devices using a graphical user interface (GUI) and a display, comprising:
displaying an object indicative of a first network device and an object indicative of a second network device on the display; and
logically disconnecting a connection of the first network device to the second network device in response to selecting the object indicative of the first network device and the object indicative of the second network device using the GUI.

11. A method of selectively disconnecting a plurality of connected network devices using a graphical user interface (GUI) and a display, comprising:
displaying an object indicative of a first network device, an object indicative of a second network device, and a connection line indicative of the first network device being logically connected to the second network device on the display; and
logically disconnecting the connection of the first network device to the second network device in response to selecting the connection line using the GUI.

12. A method of changing connections among a plurality of network devices using a graphical user interface (GUI) and a display, comprising:
displaying an object indicative of a first network device, an object indicative of a second network device, and an object indicative of a third network device on the screen of the computer; and
logically disconnecting a connection of the first network device to the second network device, and logically connecting the first network device to the third network device in response to selecting one end of an object indicative of the first network device being connected to the second network device using the GUI, the selected one end being located close to the object indicative of the second network device having been selected, and moving the selected one end to the object indicative of the third network device using the GUI.

13. An apparatus to selectively connect a plurality of network devices together using a graphical user interface (GUI) and a display, comprising:
a display device to display an object indicative of a first network device and an object indicative of a second network device on the screen of the computer; and
a device to logically connect said first network device to said second network device in response to the object indicative of said first network device and the object indicative of said second network device being selected using the GUI.

14. A program storage device readable by a machine, tangibly embodying a program of instructions executable by the machine to perform a method of selectively connecting a plurality of network devices together using a graphical user interface (GUI) and a display, the method comprising:
displaying an object indicative of a first network device and an object indicative of a second network device on the display; and
logically connecting the first network device to the second network device in response and selecting the object indicative of the first network device and the object indicative of the second network device using the GUI.

15. A method of manufacturing a virtual local area network (VLAN) having a network, a first LAN, and a second LAN, using a graphical user interface (GUI) and a display, comprising:
displaying an object indicative of a first network device in a network and an object indicative of a second network in the network on the display;
displaying an object indicative of a network device in the first LAN on the display;
displaying an object indicative of a network device in the second LAN on the display;
logically connecting a first connection device in the network to a connection device in the first LAN in response to an object indicative of the first connection device in the network and an object indicative of the connection device in the first LAN being selected using the GUI; and
logically connecting a second connection device in the network to a connection device in the second LAN in response to an object indicative of the second connection device in the network and an object indicative of the connection device in the second LAN being selected using the GUI.

16. A virtual local area network (VLAN) having a network, a first LAN, and a second LAN, using a graphical user interface (GUI) displayed on a display, the VLAN comprising:
a device to display an object indicative of a first network device in a network and an object indicative of a second network in the network on the display;
a device to display an object indicative of a network device in the first LAN on the display;
a device to display an object indicative of a network device in the second LAN on the display;
a device to logically connect a first connection device in the network to a connection device in the first LAN in response to an object indicative of the first connection device in the network and an object indicative of the connection device in the first LAN being selected using the GUI; and
a device to logically connect a second connection device in the network to a connection device in the second LAN in response to an object indicative of the second connection device in the network and an object indicative of the connection device in the second LAN being selected using the GUI.
